(19) United States
(12) Patent Application Publication
(10) Pub. No.: US 2013/0302643 A1
(43) Pub. Date: Nov. 14, 2013

(54) ALUMINIUM ALLOY FREE FROM SI PRIMARY PARTICLES

(71) Applicants: Gerd-Ulrich Grün, Troisdorf (DE); Hartmut Janssen, Hilden (DE); Katrin Kuhnke, Solingen (DE); Werner Droste, Bonn (DE)

(72) Inventors: Gerd-Ulrich Grün, Troisdorf (DE); Hartmut Janssen, Hilden (DE); Katrin Kuhnke, Solingen (DE); Werner Droste, Bonn (DE)

(73) Assignee: Hydro Aluminium Rolled Products GmbH, Grevenbroich (DE)

(21) Appl. No.: 13/945,431

(22) Filed: Jul. 18, 2013

Related U.S. Application Data
(63) Continuation of application No. PCT/EP2012/050878, filed on Jan. 20, 2012.

(30) Foreign Application Priority Data
Jan. 21, 2011 (EP) 11151662.1

(51) Int. Cl. B23K 35/28; C22C 1/02; C22C 21/02

(52) U.S. Cl. CPC B23K 35/288; C22C 21/02; C22C 1/026
USPC 428/654; 75/684; 420/532

(57) ABSTRACT

The invention relates to an aluminium alloy, and aluminium alloy product consisting at least in part of an aluminium alloy, an ingot formed from an aluminium alloy, and also a method for producing an aluminium alloy. An improved soldering process is achieved by an AlSi aluminium alloy that has the following proportions of alloy components in percentage by weight:

| | | |
|---|---|---|
| 4.5%≦ | Si | ≦12%, |
| | P | ≦10 ppm, |
| | B | ≦10 ppm, |
| 30 ppm≦ | Ti | ≦240 ppm, |
| | Fe | ≦0.8%, |
| | Cu | ≦0.3%, |
| | Mn | ≦0.10%, |
| | Mg | ≦2.0%, |
| | Zn | ≦0.20%, |
| | Cr | ≦0.05%, |

the remainder being Al and unavoidable impurities, individually at most 0.05% by weight and in total at most 0.15% by weight, wherein the aluminium alloy is free from Si primary particles with a size of more than 10 μm.

### CROSS-REFERENCE TO RELATED PATENT APPLICATIONS

This patent application is a continuation of PCT/EP2012/050878, filed Jan. 20, 2012, which claims priority to European Patent Application No. 11151662.1, filed Jan. 21, 2011, the entire teachings and disclosure of which are incorporated herein by reference thereto.

### FIELD OF THE INVENTION

The invention relates to an aluminium alloy, an aluminium alloy product consisting at least in part of an aluminium alloy, an ingot made of an aluminium alloy, and also a method of producing an aluminium alloy.

### BACKGROUND OF THE INVENTION

Aluminium alloys with Si contents from 4.5% by weight to 12% by weight are used above all for soldering components, preferably aluminium components, due to the relatively low melting point. The aluminium solder consisting of an AlSi aluminium alloy may be provided for example in the form of soldering foils, but also by a composite material which comprises an AlSi aluminium alloy layer. In particular, if a large number of soldering points are to be soldered and the components have a complex shape, such as heat exchangers, strips, sheets or semifinished products comprising an AlSi aluminium alloy layer are often used. Heat exchangers of motor vehicles are often soldered with use of an aluminium solder. The solder layers are generally very thin in order to save material and also so as not to negatively influence the properties of the core material provided with the composite material. Due to the increasing reduction of the thickness of the solder layers and of the core material, increased demands are placed on the structure of the solder layers. It is known from the field of mould casting to include enriching elements such as strontium and sodium or refining elements such as antimony into the alloy in order to influence the eutectic structure or the eutectic structure portions. These enriching or refining alloy elements are not considered however with use in aluminium solders, since they can interfere with the soldering process and can impair recycling. With the conventional production of AlSi aluminium alloys, a primary aluminium is melted together with silicon in a smelting furnace or casting furnace and is alloyed with other alloy elements. For grain refinement of the primary alpha aluminium phase, aluminium titanium boride (AlTiB) wires are generally used and are supplied to the alloy in the molten state. A fine structure, which was previously sufficient for the AlSi aluminium alloy for the use as a solder layer, is thus produced. It has been found, however, that the soldering process could not be carried out sufficiently reliably with extremely thin aluminium solder layers. In addition, melting and erosion or holes in the components occurred after the soldering process. In particular, this affects components having thin wall thicknesses.

### SUMMARY OF THE INVENTION

Proceeding from this basis, one object of the present invention is to provide an AlSi aluminium alloy which ensures an improved soldering process. A further object of the invention is to propose an aluminium alloy product, an ingot for producing aluminium alloy products, and also a method for producing the aluminium alloy.

In accordance with a first teaching of the present invention, the stated object is achieved by an AlSi aluminium alloy having the following proportions of alloy components in percentage by weight:

| | | |
|---|---|---|
| 4.5%≦ | Si | ≦12%, |
| | P | ≦10 ppm, |
| | B | =10 ppm, |
| 30 ppm≦ | Ti | ≦240 ppm, |
| | Fe | ≦0.8%, |
| | Cu | ≦0.3%, |
| | Mn | ≦0.10%, |
| | Mg | ≦2.0%, |
| | Zn | ≦0.20%, |
| | Cr | ≦0.05%, |

the remainder being Al and unavoidable impurities, individually not exceeding 0.05% by weight and in total not exceeding 0.15% by weight, wherein the aluminium alloy is free from primary Si particles with a size of more than 10 μm.

The inventors have found that the soldering problems are caused in particular by primary Si particles, in particular when these have a size of more than 10 μm. The aluminium alloy according to the invention preferably even no longer has any primary Si particles. Primary Si particles are particles that consist of pure silicon and are present in crystalline form in conventional aluminium alloys. The inventors have found, however, that, during the soldering process, primary Si particles that are larger than 10 μm lead to a local surplus of Si in the solder layer and that the core material is thus likewise melted locally in the surrounding area of the primary Si particles. This then leads, during the soldering process, to erosion or formation of a hole in the product coated with an aluminium solder layer. The avoidance of these primary Si particles with a size of more than 10 μm means that the soldering process can be carried out faultlessly and that there is no local melting of the aluminium alloy core material. This is true in particular for aluminium solder layers and aluminium alloy core materials that are particularly thin. The thicknesses of these materials lie in a range from 15 μm to 30 μm for the solder layer and 40 μm to 120 μm, preferably 50 μm to 120 μm for the core material, since the effect of the hole formation due to the presence of primary Si particles with a size of more than 10 μm occurs to an increased extent at these layer thicknesses. The use of the aluminium alloy according to the invention is particularly advantageous when extremely thin solder layers with thicknesses from 5 μm to 20 μm are used. At the same time, however, due to the Ti content from 30 ppm to 240 ppm, the AlSi aluminium alloy, in conjunction with the local contents of boron and phosphorous, ensures that a particularly fine structure without primary Si particles with a size of more than 10 μm is provided and is particularly suitable for the production of very thin solder layers. Due to the fine structure of the aluminium alloy according to the invention, a solder layer produced therefrom can specifically be subjected without difficulty, for example together with the solder-plated material, to forming processes without loss of the very good soldering properties of the solder layer. As a result, a particularly reliable soldered connection, above all with very low solder layer thicknesses, can be provided with the aluminium alloy according to the invention.

The aluminium alloy within the limits provided beforehand for B, P and Ti and also irrespectively of the absent primary Si particles with a size of more than 10 μm preferably corresponds to one of the alloy specifications of type AA 4043, AA 4343, AA 4045, AA 4044 or AA 4104. The specific alloy types are used in combination with different aluminium alloys as aluminium solders in rather specific fields of application.

The aluminium alloy of type AA 4043 for example has an Si content from 4.5 to 6.0% by weight, an Fe content of 0.8% by weight at most, a Cu content of 0.30% by weight at most, an Mn content of 0.05% by weight at most, an Mg content of 0.1% by weight at most, a Zn content of 0.10% by weight at most, and also a Ti content of 0.20% by weight at most. Typical applications of the alloy AA 4043 lie in the use as aluminium solder preferably in combination with fluxing agents.

The aluminium alloy AA 4343 for example has an Si content from 6.8 to 8.2% by weight, an Fe content of 0.8% by weight at most, a Cu content of 0.25% by weight at most, an Mn content of 0.10% by weight at most, and a Zn content of 0.20% by weight at most. The aluminium alloy of type AA 4343 is preferably used in combination with fluxing agents for soldering in inert gas atmosphere or in a CAB (controlled atmosphere brazing) method.

The aluminium alloy of type AA 4045 provided with a higher Si content contains 9.0 to 11.0% by weight of Si, at most 0.8% by weight of Fe, at most 0.30% by weight of Cu, at most 0.05% by weight of Mn, at most 0.05% by weight of Mg, at most 0.10% by weight of Zn and at most 0.20% by weight of Ti. This aluminium alloy is likewise preferably used in combination with fluxing agents for soldering in inert gas atmosphere or in a CAB method.

The aluminium alloy of type AA 4044 contains 7.8% by weight to 9.2% by weight of Si, at most 0.8% by weight of Fe, at most 0.25% by weight of Cu, at most 0.10% by weight of Mn and at most 0.20% by weight of Zn. It is likewise used for the CAB soldering method.

Lastly, the alloy of type AA 4104 contains 9.0 to 10.5% by weight of Si, at most 0.8% by weight of Fe, at most 0.25% by weight of Cu, at most 0.1% by weight of Mn, 1.0 to 2.0% by weight of Mg, and at most 0.05% by weight of Zn and 0.02 to 0.20% by weight of Bi. This alloy type is preferably used as a solder in vacuum soldering.

All five alloy types contain impurities in a content of at most 0.05% by weight individually, and in total at most 0.15% by weight. The aforementioned aluminium alloys are particularly suitable for use as solder layers in combination with different alloy types. A common feature of all alloys is that they comprise primary Si particles with conventional production, whereas the aluminium alloys according to the invention with Ti contents from 30 ppm to 240 ppm and also B and P contents of less than 10 ppm are free from primary Si particles with a size of more than 10 μm. The aluminium alloy according to the invention is additionally preferably completely free from primary Si particles, such that particularly thin aluminium solder layers can be produced with the aluminium alloy according to the invention and provide reliable soldered joints.

If, in accordance with a first embodiment of the aluminium alloy according to the invention, the P content is limited to at most 5 ppm and/or the B content is limited to at most 7 ppm, the formation of primary Si particles in the aluminium alloy can be even better suppressed.

An optimal result with regard to a fine structure can be achieved in accordance with a next embodiment of the aluminium alloy in that the Ti content is 140 ppm to 240 ppm. In addition, good castability with a fine structure is achieved by limiting the Ti content to 140 ppm to 240 ppm.

In accordance with a second teaching of the present invention, the above-stated problem is achieved by an aluminium alloy product consisting at least in part of an aluminium alloy according to the invention. Corresponding aluminium alloy products can have extremely thin solder layers and can still be soldered very well. For example, the aluminium solder layers can have thicknesses in the range from 15 μm to 30 μm. Here, the core material can have thicknesses from 40 μm to 120 μm, preferably 50 μm to 120 μm. Even with particularly thin solder layers having thicknesses from 5 μm to 20 μm, the aluminium alloy product according to the invention additionally demonstrates very good soldering properties.

The aluminium alloy products can be provided in a particularly simple manner if the aluminium alloy product is a strip and comprises at least one further layer made of aluminium or a further aluminium alloy. The strip-shaped aluminium alloy product can have a very thin aluminium solder layer consisting of the aluminium alloy according to the invention and can still have particularly good soldering properties. The strip can be easily separated into a multiplicity of sheets, which are then subjected to further processing steps in order to produce semifinished products or finished components that can be soldered.

The strip is preferably produced by roll cladding or composite casting, wherein both aluminium alloy layers are integrally connected at their interfaces to one another. Both methods can be used economically to produce aluminium composite materials that have a layer formed from an aluminium alloy according to the invention as an aluminium solder layer.

Since, with the aluminium alloy according to the invention, a soldered joint that can be produced particularly reliably can be provided, it is advantageous if the aluminium alloy product is formed as part of a soldered component, in particular of a heat exchanger. As already previously mentioned, soldered joints are a key element with different components, in particular in the case of heat exchangers of motor vehicles. The aluminium alloy product according to the invention is particularly suitable for providing reliable soldered joints.

In accordance with a third teaching of the present invention, the previously stated object is also achieved by an ingot consisting of an aluminium alloy according to the invention, wherein the ingot can be used for production of an aluminium alloy product according to the invention and the milled ingot comprises no primary Si particles with a size of more than 10 μm, wherein, on a slice of the milled ingot cut out perpendicularly with respect to the casting direction, the number of primary Si particles are determined in the middle of the ingot at the surface, at a depth of one quarter of the thickness of the ingot, and in the centre of the ingot over an area of at least 600 mm². The ingot according to the invention is therefore particularly suitable for being further processed to form a plating sheet or to form a soldering foil. The plating sheet is normally applied to the core material or core ingot and is accordingly roll-clad in order to provide an aluminium composite material that can be soldered. As a result, the ingot according to the invention can be used to produce aluminium alloy products that can be soldered particularly effectively. The ingot according to the invention is preferably free from primary Si particles, that is to say, in a slice separated from the milled ingot perpendicularly with respect to the casting direction of the ingot, no primary Si particles can be ascertained in the middle of this slice in areas of at least 600 mm² at the surface, at a height of one quarter of the ingot thickness, and in the centre of the ingot. The primary Si particles are counted on the polished sections under a microscope within the corresponding area.

As already discussed, ingots according to the invention comprise no primary Si particles with a size of more than 10 μm, and preferably do not even comprise any primary Si particles. The ingots according to the invention therefore differ considerably from conventionally produced ingots for producing aluminium alloy products.

In accordance with a fourth teaching of the present invention, the above-stated problem is solved in that a method for producing an aluminium alloy according to the invention is provided, in which
pure aluminium with a P content of at most 10 ppm and a B content of at most 10 ppm and also unavoidable impurities individually of 0.05% by weight and in total of 0.2% by weight at most is melted in a smelting furnace,
pure silicon is alloyed in the smelting furnace until an Si content from 4.5% by weight to 12% by weight of the aluminium alloy is reached,
the following are optionally alloyed in the smelting furnace as further alloy components in percentage by weight or are already contained at least in part in the pure aluminium

Fe with up to 0.8%,

Cu with up to 0.3%,

Mn with up to 0.10%,

Mg with up to 2.0%,

Zn with up to 0.20%,

Cr with up to 0.05%,
titanium in the form of a master alloy is alloyed in the smelting furnace in order to adjust the Ti content to 30 ppm to 240 ppm, wherein the addition of grain refining agents that contain titanium borides is omitted.

It has been found that titanium borides, which are added for grain refinement, are one of the causes leading to the formation of primary Si particles with a size of more than 10 μm. In the method according to the invention, the addition of these titanium borides is omitted, such that, as a result, no primary Si particles can be found in the produced aluminium alloy. Here, a master alloy in the form of an AlTi5 or AlTi10 alloy for example can be used in order to increase the Ti content. These aluminium alloys can be alloyed both in bar form, in tablet form and as pigs of the melt.

A further increase of the reliability when producing aluminium alloys free from primary Si particles is achieved in that the pure aluminium has a P content of at most 5 ppm and/or a B content of at most 7 ppm. It has been found that these contents of phosphorous and/or boron lead to a further reduction of the size of the primary Si particles and also to aluminium alloys completely free from primary Si particles.

Lastly, the structure of the aluminium alloy according to the invention can be particularly fine, and, at the same time, the casting properties of the aluminium alloy are not worsened, since the Ti content is preferably 140 ppm to 240 ppm.

### BRIEF DESCRIPTION OF THE DRAWINGS

The invention will be explained hereinafter in greater detail on the basis of exemplary embodiments in conjunction with the drawings, in which:

FIG. 1 shows a sectional view of a milled casting ingot with sketched areas for determining the number of primary Si particles,

FIGS. 2 and 3 show a greatly enlarged view of a sectional area of ingots with conventional production,

FIGS. 4 and 5 show a greatly enlarged view of a sectional area of ingots of two exemplary embodiments of the invention.

### DETAILED DESCRIPTION OF THE INVENTION

A total of four exemplary embodiments were examined, which were very similar in terms of their composition and differed merely by the type of manufacture of the aluminium alloy. The contents of the alloy components of the exemplary embodiments are specified in Table 1 in percentage by weight or ppm.

TABLE 1

| Sample | | Si | Fe | Cu | Mn | Mg | Ti | Cr | Zn | B | P |
|---|---|---|---|---|---|---|---|---|---|---|---|
| Vla | P.A. | 10.2 | 0.07 | <0.001 | <0.005 | <0.005 | 50 ppm | <0.001 | 0.005 | 11 ppm | 7 ppm |
| Vlb | P.A. | 10.1 | 0.07 | <0.001 | <0.005 | <0.005 | 30 ppm | <0.001 | 0.005 | 11 ppm | 7 ppm |
| V4a | Inv. | 10.0 | 0.06 | <0.001 | <0.005 | <0.005 | 50 ppm | <0.001 | <0.005 | 7 ppm | 4 ppm |
| V4b | Inv. | 10.0 | 0.04 | 0.0059 | <0.005 | <0.005 | 30 ppm | <0.001 | 0.05 | 2 ppm | <4 ppm |

As can be seen from Table 1, the conventionally produced comparison alloys V1a, V1b have a content of approximately 10% silicon. The further components of the comparison alloys V1a and V1b can be deduced from Table 1. This is also true for the exemplary embodiments according to the invention, which likewise have a Si content of approximately 10%. Both the comparison examples V1a and V1b and the exemplary embodiments according to the invention V4a and V4b have P contents of less than 10 ppm. The B contents of the comparison alloys V1a and V1b are above 10 ppm, and those of the exemplary embodiments according to the invention V4a and V4b are less than 10 ppm.

The following tests were then carried out with the comparison alloy V1a. The alloy was first produced conventionally on the basis of a standard primary aluminium and silicon in foundry quality together with use of grain refining agents in the form of AlTiB bars.

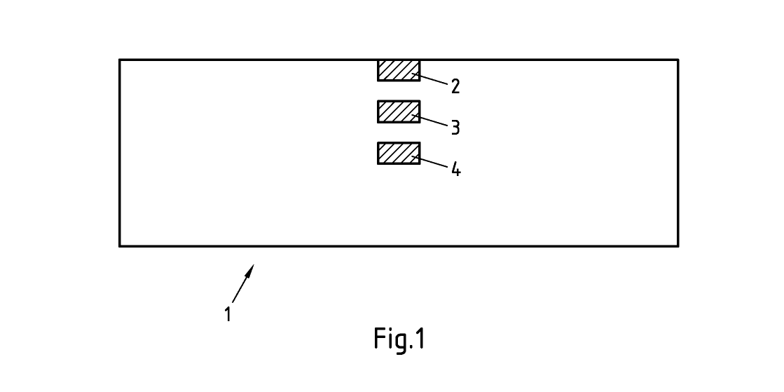

The ingot was cast in the casting size 600 mm×200 mm and milled, that is to say the outer shell, which is up to approximately 20 mm thick, was removed. A slice as illustrated in FIG. 1 was separated from the ingot thus milled, perpendicularly with respect to the casting direction. Areas measuring 30 mm×20 mm were examined at three different points, namely in the middle of the ingot at the surface 2, at the height of one quarter of the ingot thickness 3, and in the centre of the ingot 4, for the presence of primary Si particles.

The areas measuring 30 mm×20 mm were separated from the ingot slice at the aforementioned points and were embedded in an epoxy resin in order to facilitate the sample handling. The embedded samples were then first ground manually using SiC paper and abrasive cloth or a non-woven abrasive having a grain size of up to 2400. The duration of the grinding process was approximately 10 to 20 s with the various grain sizes. The subsequent semi-automatic polishing was carried out initially with 6 μm and then with 3 μm of polycrystalline diamond suspension for 8 to 9 minutes in each case. Final polishing was carried out using an oxide polishing suspension with a grain size of 0.25 μm for approximately 2 to 5 minutes. The polished sections thus prepared were evaluated under a reflected light microscope with 100× to 200× magnification.

At the same time, different manufacturing parameter studies, for example different killing times, with or without argon gas flushing, and changes to the gas flushing mixture, were carried out with the comparison alloy V1a. It was found that, irrespective of the aforementioned parameters of the melt treatment, coarse primary Si particles were present in the rolling ingot. The results of the number and size of the primary Si particles of comparison alloy V1a are shown in Table 2. An accumulation of the primary Si particles with a size of more than 12 μm could be seen at the surface.

The comparison alloy V1b was manufactured similarly to the comparison alloy V1a, wherein the melt temperature was raised, however, from approximately 750° C. to 850 ° C. before the rolling ingot was cast. The comparison alloy V1b, however, also clearly demonstrated the presence of coarse primary Si particles, which is problematic, in particular with the use as a solder layer, for example in heat exchangers. The results of the comparison alloys are presented in Table 2.

TABLE 2

| | Number of primary Si Particles | | | Average size of |
|---|---|---|---|---|
| | | ¼ Ingot | Ingot | the primary |
| Sample | Surface | thickness | centre | Si particles (μm) |
| V1a | 53 | 29 | 171 | 12-22 |
| V1b | 63 | 21 | 211 | 12-28 |
| V4a | 0 | 0 | 0 | 0 |
| V4b | 0 | 0 | 0 | 0 |

The alloys V4a and V4b according to the invention were produced by contrast without the use of grain refining agents containing titanium borides. After casting, a slice was separated from a cast ingot in accordance with that illustrated in FIG. 1 and the surface areas were examined. Surprisingly, as presented in Table 2, no primary Si particles could be determined in the examined surface areas. The two alloys according to the invention V4a and V4b do not differ in terms of the method parameters from the comparison alloy V1a, the grain refinement was merely achieved as a result of the addition of AlTi5 or AlTi10 master alloys and not with the addition of titanium borides.

The comparison alloy V4b additionally differs from the test alloy V4a in that highly pure silicon was used in order to clarify the influence of the purity of the silicon on the formation of the primary Si particles. By contrast, the comparison alloy V4a was produced by alloying silicon, which is suitable for foundries. It was found that there was no formation of coarse primary Si particles irrespective of the purity of the silicon, provided the addition of titanium borides for grain refinement was omitted. The contents according to the invention of Ti of 50 and 30 ppm were achieved by the addition of a commercially available AlTi5 master alloy, wherein the values for the contents of phosphorous and boron were also below the stipulated limit of 10 ppm.

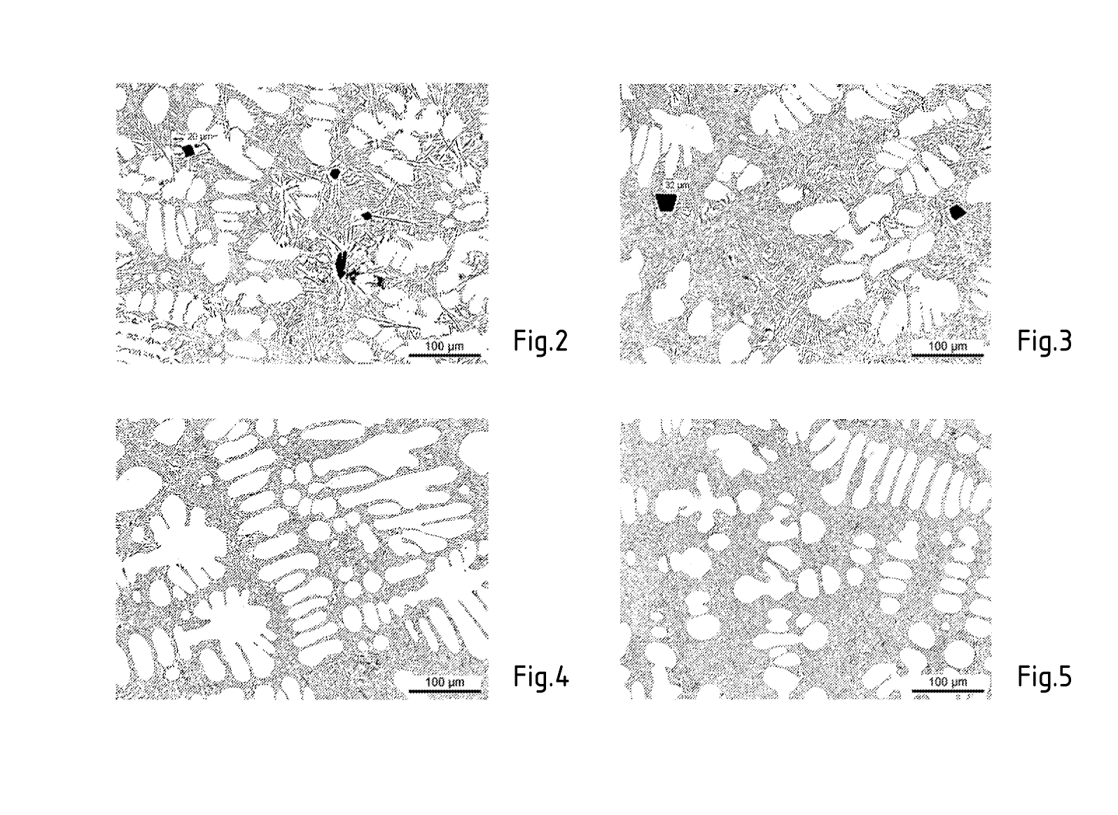

Ingots were cast from the four different aluminium alloys and a slice was separated from the ingots, in each case perpendicularly with respect to the casting direction. Areas measuring 30 mm×20 mm were prepared at points 2, 3, 4 to form polished sections, and the number of primary Si particles was determined. The areas illustrated in FIGS. 2, 3, 4 and 5 originate from the centre of the ingots. The greatly enlarged images in FIGS. 2, 3, 4 and 5 are approximately 500 μm×375 μm in size.

FIG. 2 shows an enlarged view of the polished section of an ingot from the centre of the ingot from comparison alloy V1a. FIG. 3 shows the same from the comparison alloy V1b. In both polished sections, it can be clearly seen that coarse primary Si particles are present that have a size of approximately 20 μm and more. By contrast, FIGS. 4 and 5, which are associated with the alloys according to the invention V4a and V4b, demonstrate no primary Si particles in the enlarged sectional views.

The aluminium alloy according to the invention can be used particularly effectively in this respect as an aluminium solder layer, since it in particular also enables extremely thin solder layers without resulting in problems with regard to hole formation during the soldering process. In this regard, aluminium alloy products that can be soldered particularly well can be provided with use of the aluminium alloy according to the invention.

1. An aluminium alloy product with an aluminium solder layer, characterised in that the aluminium alloy of the aluminium solder layer has the following proportions of alloy components in percentage by weight:

| | | |
|---|---|---|
| 4.5%≦ | Si | ≦12%, |
| | P | ≦10 ppm, |
| | B | ≦10 ppm, |
| 30 ppm≦ | Ti | ≦240 ppm, |
| | Fe | ≦0.8%, |
| | Cu | ≦0.3%, |
| | Mn | ≦0.10%, |
| | Mg | ≦2.0%, |
| | Zn | ≦0.20%, |
| | Cr | ≦0.05%, |

the remainder being Al and unavoidable impurities, individually at most 0.05% by weight and in total at most 0.15% by weight, and
the aluminium solder layer is free from primary Si particles with a size of more than 10 μm.

2. The aluminium alloy product according to claim 1,
characterised in that
the P content is at most 5 ppm and/or the B content is at most 7 ppm.

3. The aluminium alloy product according to claim 1 or 2,
characterised in that
Ti content is 140 ppm to 240 ppm.

4. The aluminium alloy product according to claims 1 to 3,
characterised in that
the aluminium alloy product is a strip and comprises at least one further layer formed from aluminium or an aluminium alloy.

5. The aluminium alloy product according to claim 4,
characterised in that
the strip is produced by roll cladding or composite casting.

6. The aluminium alloy product according to one of claims 1 to 5,
characterised in that
the aluminium alloy product is formed at least as part of a soldered component, in particular of a heat exchanger.

7. A method for producing an aluminium alloy of an aluminium solder layer of an aluminium alloy product according to one of claims 1 to 3, in which
pure aluminium with a P content of at most 10 ppm and a B content of at most 10 ppm, the remainder being aluminium with unavoidable impurities individually of 0.05% by weight and in total at most 0.2% by weight, is melted in a smelting furnace,
the following are optionally alloyed in the smelting furnace in percentage by weight as further alloy components or are already contained at least in part in the pure aluminium
Fe with up to 0.8%,
Cu with up to 0.3%,
Mn with up to 0.10%,
Mg with up to 2.0%,
Zn with up to 0.20%,
Cr with up to 0.05%,
silicon is alloyed in the smelting furnace until a Si content from 4.5% by weight to 12% by weight of the aluminium alloy is achieved, and
titanium is alloyed in the smelting furnace in the form of a master alloy in order to adjust the Ti content to 30 ppm to 240 ppm, wherein the addition of grain refining agents containing titanium borides is omitted.

8. The method according to claim 7,
characterised in that
the pure aluminium has a P content of at most 5 ppm
and/or a B content of at most 7 ppm.

9. The method according to one of claim 7 or 8,
characterised in that
the Ti content is 140 ppm to 240 ppm.

10. Use of an aluminium alloy as an aluminium solder layer,
characterised in that
the aluminium alloy has the following proportions of alloy components in percentage by weight:

| | | |
|---|---|---|
| 4.5%≦ | Si | ≦12%, |
| | P | ≦10 ppm, |
| | B | ≦10 ppm, |
| 30 ppm≦ | Ti | ≦240 ppm, |
| | Fe | ≦0.8%, |
| | Cu | ≦0.3%, |
| | Mn | ≦0.10%, |
| | Mg | ≦2.0%, |
| | Zn | ≦0.20%, |
| | Cr | ≦0.05% |

the remainder being Al and unavoidable impurities, individually at most 0.05% by weight and in total at most 0.15% by weight, and the aluminium solder layer is free from primary Si particles with a size of more than 10 μm.
